(19) United States
(12) Patent Application Publication
(10) Pub. No.: US 2013/0159155 A1
(43) Pub. Date: Jun. 20, 2013

(54) TECHNIQUE FOR AUTOMATICALLY INPUTTING DATA INTO AUTO BUDGET BOOK

(71) Applicant: Hyundai Motor Company, Seoul (KR)

(72) Inventors: Kyeong-Jin Kim, Pohang (KR); Jaeseok Park, Hwasung (KR)

(73) Assignee: Hyundai Motor Company, Seoul (KR)

(21) Appl. No.: 13/687,783

(22) Filed: Nov. 28, 2012

(30) Foreign Application Priority Data
Dec. 15, 2011 (KR) 10-2011-0135259

(51) Int. Cl. G06Q 40/00

(52) U.S. Cl. CPC G06Q 40/00
USPC 705/35

(57) ABSTRACT

Disclosed is a technique for automatically inputting information into an auto budget book program. More specifically, an auto-budget-book-program is installed within an AVN (Audio Video Navigation) system and is run each time a vehicle equipped with an AVN is refueled. The AVN system monitors a fuel gage sensor to determine when the vehicle is being refueled and activates the auto budget program as result of such a determination. Additionally, this information provided by fuel gage sensor is automatically input into the AVN system to induce users to utilize an auto budget book and as a result reduce fuel costs

### CROSS-REFERENCE TO RELATED APPLICATION

The present application claims priority to Korean Patent Application No. 10-20110135259, filed on Dec. 15, 2011, the entire contents of which is incorporated herein for all purposes by this reference.

### BACKGROUND OF THE INVENTION

1. Field of the Invention

The present invention relates to a technique for an automatic input system of auto budget book, and more particularly, to a technique for an automatic input system of an auto budget book, which is operated by a program installed on and executed by an AVN (Audio Video Navigation) wherein the program is run each time a vehicle equipped with an AVN is refueled.

2. Description of Related Art

Typically, an auto budget book is used to reduce the maintenance cost for a vehicle. The auto budget book is a means of organizing the maintenance costs of a vehicle. These maintenance costs typically include fuel costs and are documented in a ledger format. Recently auto budget books, such as the one described above, have began to be incorporated into navigational devices in a computer readable medium containing program instructions that are executed by a processor. Using this technology, a user can input data into or read an auto budget book via their navigation system installed inside a vehicle without the need for additional physical auto budget book.

These convention systems include inputting functions in the navigations system as well for the driver's convenience. However, in reality it is not widely utilized by the users because of the effort it requires to manual input the data into the navigation system.

Drivers have found that it is difficult to input data into system while the driver is driving. Furthermore, even when the vehicle is at a complete stop, such as when it is being refueled, for example, the user most of the time forget to input the necessary data into the auto budget book because often times a driver is in a hurry or simply forgets.

Also, in the conventional system, the auto budge book system is a function which must be accessed through a plurality of menus on the user interface of the navigation device in order to input data into the auto budget book, as illustrated in FIG. 1. Since the auto budget book program is not a main function of the navigation system, it is not so easily accessible on the user interface, and usually the user has to go through several menus to be able to use the auto budget book.

Therefore, an auto budget book provided by the traditional navigation such as the one above is difficult to use, and is not as accessible as most driver's would wish thereby resulting in poor utilization of the system by consumers.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

The present invention provides a technique for an automatic input system of auto budget book which incorporates into an audio video navigation (AVN) system an auto-budget-book-program that is run each time a vehicle equipped with an AVN is refueled, induces users to perform input into an auto budget book so that its utilization is increased and fuel cost is reduced.

The technical problems that the present invention is set out to solve are not limited to the ones mentioned above, and those that are not mentioned shall be clearly understood by a person skilled in the art from looking at the specification of the present invention.

In order for the present invention to achieve the goal set forth above, a system for automatic input system of auto budget book include a AVN system and a sensor (e.g., a fuel gauge sensor) in communication with the AVN system. The AVN system includes an auto budget book module that is configured to receive the fuel quantity data from the fuel gauge sensor periodically, output the auto budget book module when the AVN system finds that the fuel quantity increasing, and input the fuel quantity data received from the fuel gauge sensor into the auto budget book module.

In addition, in some embodiments of the present invention, the AVN system is characterized in that it includes a GPS module and a wireless communication module, and is further configured to receive position information from the GPS module, receive oil price information from the wireless communication module and input any received information into the auto budget book module.

Advantageously, the AVN system provides the driver with an error correction user interface on the auto budget book so that the driver can correct errors identified in the inputted information.

Also, in another aspect of the present invention, a method automatic input into an auto budget book system includes measuring, by a sensor, (e.g., a fuel gage sensor) the fuel quantity and inputting the fuel quantity into the AVN system. The AVN system monitors the fuel quantity and determines whether the fuel quantity is increasing. In response to the AVN system determining that the fuel quantity is increase, the AVN system outputs an auto budget book module and inputs the received fuel quantity data into the auto budget book module.

Furthermore, in some exemplary embodiments of the present invention, the method further include receiving position information from a GPS module, receiving oil price information from a wireless communication module and inputting the received information into the auto budget book module.

Also, the AVN system further include providing the driver with an error correction user interface on the auto budget book so that the driver can correct errors in the inputted information.

By displaying the auto budget book module on the AVN inside the vehicle to the driver each time a vehicle is being refueled, the present invention induces the use of the auto budget book and enhances the utilization of the auto budget book, and as a result, has the effect of reducing the fuel cost while at the same time reducing the level of input by the driver.

Moreover, since the auto budget book system is automatically displayed to on the navigation interface to the driver when the vehicle is being refueled, the driver may efficiently and quickly input the necessary information into it or read information supplied quickly and accurately.

Also, the auto budget book system has the effect of being automatically updated by recognizing the current position of the vehicle through a GPS module, receiving oil price information from a wireless communication module such as a Transport Protocol Experts Group (TPEG) and inputting the information automatically into the auto budget book module installed on the AVN system.

### BRIEF DESCRIPTION OF THE DRAWINGS

FIG. 1 illustrates a navigation system which provides a conventional auto budget book.

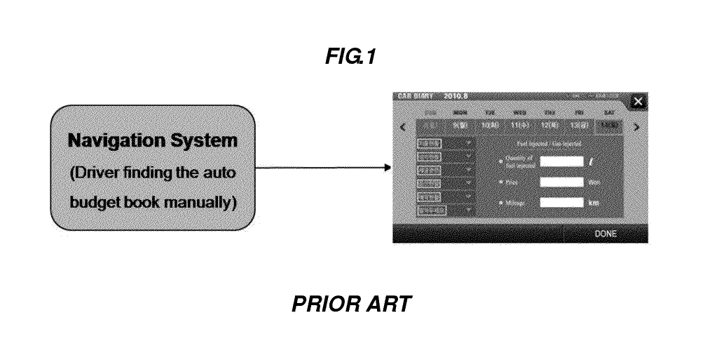

FIG. 2 is a block diagram illustrating an exemplary embodiment of the present invention for implementing an automatic input system of auto budget book.

FIG. 3 is a block diagram illustrating an exemplary method for controlling a system for automatic input into an auto budget book according to an exemplary embodiment of the present invention.

### DETAILED DESCRIPTION

Reference will now be made in detail to various embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Hereafter, with reference to the attached drawings, the preferred embodiment of the present invention will be described in detail. Before proceeding, it should be noted that the terminologies and words used on this specification and in the claims are not to be interpreted solely as the general or dictionary meanings, and they should be interpreted as the meanings and the concept which correspond with the technological ideas of the present invention based on the principle that the inventor can properly define the concept of the terminologies in order to explain his own invention in the best possible way. Therefore, the compositions described in the embodiments and the drawings of this specification are merely the most preferred types of embodiment and they do not represent the entire technological ideas of the present invention, and thus, it should be understood that there can be a variety of equivalents and alterations, which can replace these embodiments at the time of filing this application.

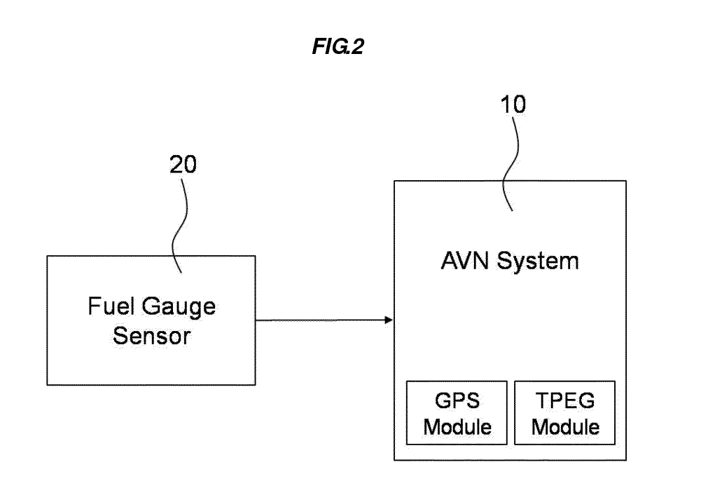

FIG. 2 is a block diagram illustrating an exemplary embodiment of the present invention. As illustrated, a technique for implementing an automatic input system of auto budget book includes an AVN system included in a vehicle and a sensor configured to measure the amount of fuel in a fuel tank (e.g., a fuel gage sensor).

The AVN system may include a navigation module and is configured to provide necessary road information to the user. Preferably, the AVN system recognizes vehicles location and position and communicates data including a global positioning system (GPS) module and wireless communication (including, for example, publicly known 2G, 3G, 3.5G, 4G, Wi-Fi, TPEG module).

Also, in an exemplary embodiment of the present invention, the AVN system may include an auto budget book module which may be identical to any publicly known auto budget book module. [0029] The sensor is, for example, a fuel gage sensor that measures the quantity of fuel inside the fuel tank and interworks with the AVN system. Hereinafter, for exemplary purposes, the sensor is referred to as a fuel gage sensor.

The AVN system in the illustrative embodiment of the present invention is configured to monitor and determine whether the vehicle is being refueled or not using information inputted by and from the fuel gauge sensor. In other words, the AVN system receives the information inputted from the fuel gauge, detects changes in the fuel quantity periodically, and in response to determining that the fuel quantity is increasing, the AVN system will be able to tell whether the vehicle is being refueled.

In some exemplary embodiments of the present invention, when the AVN system determines that the vehicle is being refueled, the AVN system outputs (displays/executes) the auto budget book module and automatically inputs information relating to the quantity of fuel injected, the price associated with refueling and oil prices, which it received from the fuel gauge sensor, the GPS module and the wireless communication module, respectively.

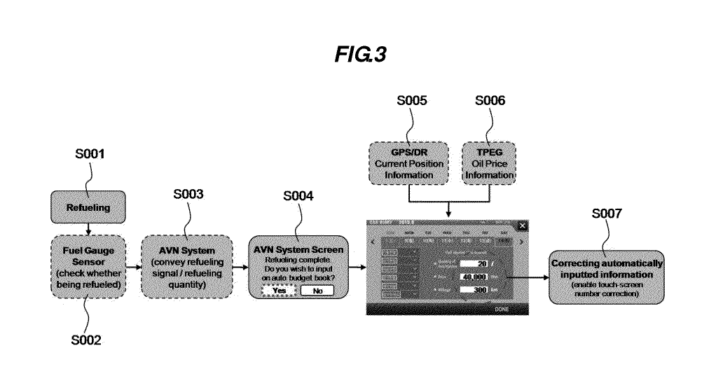

Hereafter, in reference to FIG. 3, the method of controlling an automatic input system for an auto budget book as described above is explained. FIG. 3 is a block diagram illustrating a method for controlling an automatic input system for an auto budget book according to an exemplary embodiment of the present invention.

First, when a user begins refueling the vehicle (S001), a fuel gauge sensor installed in the fuel tank of the vehicle, periodically measures the fuel quantity and transmits the information to the AVN system (S002). The AVN system then monitors and determines whether the fuel quantity data periodically received from the fuel gauge sensor is increasing, and if the fuel quantity data is increasing, the AVN system will then determine that the vehicle is being refueled (S003). Once the AVN system determines that the vehicle is being refueled, the AVN system will automatically output (display/execute/activate) the auto budget book module and display a user interface to a driver. At this time, the AVN system may display the user interface in which the user can decide whether he desires the auto budget book to be outputted or not (S004). However, the present invention is not limited to such settings, and can be configured so that the auto budget book is outputted instantly without user confirmation.

Meanwhile, when the auto budget book program is run, the AVN system detects the current location and position of the vehicle based on data from the GPS module (GPS/DR) included in the AVN system, matches the current location with map data and detects the closest gas station (S005). In addition, the AVN system receives oil/gas/fuel price data of the detected gas station using a wireless communication module and calculates the final refueling price (S006). In the above step, the final refueling price can be calculated using the oil price data from the AVN system and the fuel quantity inputted from the fuel gauge sensor, and the final fueling price that is calculated is automatically inputted to the auto budget book module.

Since the above automatically-inputted data is automatically calculated by, for example, a processor in the AVN system, there is a possibility of error. Therefore, the AVN system may also provide the driver with a separate control interface on the user interface so that the driver can correct errors in the automatically inputted information (S007).

Advantageously, the present invention provides the driver with the auto budget book information on an AVN system included inside the vehicle when the vehicle is being refueled, and, depending on the refueling status, the driver can monitor expenses associated with fuel costs of the vehicle as well as oil costs. Furthermore, since the fuel data is inputted automatically into the auto budget book driver convenience is also increased.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications within the spirit of the invention and scope of the Claims to be defined below.

What is claimed is:

1. A system automatically inputting data into an auto budget book of a vehicle, the system comprising;
an audio video navigation (AVN) system including at least a processor and display and wherein an auto budget book module is installed thereon; and
a fuel gauge sensor in communication with the AVN system,
wherein the AVN system receives fuel quantity data from the fuel gauge sensor periodically, activates the auto budget book module in response to determining that a fuel quantity is increasing, and automatically inputs the fuel quantity data received from the fuel gauge sensor into the auto budget book module.

2. The system according to claim 1, wherein the AVN system includes a global positioning system (GPS) module and a wireless communication module, and is further configured to receive location information from the GPS module, receive fuel price information from the wireless communication module and input the location and fuel price information into the auto budget book module automatically.

3. The system according to claim 1, wherein the AVN system provides a driver with an error correction user interface on a user interface of the AVN system to allow the driver to correct errors in the inputted information.

4. A method comprising;
measuring, by a sensor, a fuel quantity and inputting the fuel quantity into an audio video navigation (AVN) system;
determining, by the AVN system, whether the fuel quantity is increasing;
activating an auto budget book module in response to the AVN system determining the fuel quantity is increasing; and
automatically inputting, by an AVN system, the received fuel quantity data into the auto budget book module.

5. The method according to claim 4, wherein the AVN system includes a global positioning system (GPS) module and a wireless communication module, and the method further includes receiving location information from the GPS module, receiving fuel price information from the wireless communication module and automatically inputting the location and fuel price information into the auto budget book module.

6. The method according to claim 4, the method further comprising;
providing a driver with an error correction user interface on a user interface of the AVN system to allow the driver to correct errors in the inputted information.
